(19) United States
(12) Patent Application Publication
(10) Pub. No.: US 2017/0116640 A1
(43) Pub. Date: Apr. 27, 2017

(54) Communicating Context Information Among Portable Program Modules

(71) Applicants: Adam Sah, Santa Cruz, CA (US); Alec Go, Durham, NC (US); Ronald Ho, Fremont, CA (US)

(72) Inventors: Adam Sah, Santa Cruz, CA (US); Alec Go, Durham, NC (US); Ronald Ho, Fremont, CA (US)

(21) Appl. No.: 12/250,105

(22) Filed: Oct. 13, 2008

Related U.S. Application Data
(60) Provisional application No. 61/066,132, filed on Oct. 15, 2007.

(51) Int. Cl. G06F 17/30; G06Q 30/00; G06Q 30/02

(52) U.S. Cl. CPC G06Q 30/0256

(57) ABSTRACT

The subject matter of this specification can be embodied in, among other things, a method that includes receiving, at a first portable program module in a first web-accessible container document at a client device, context information from a second portable program module in a second web-accessible container document at the client device. The method further includes identifying advertisement information for presentation to a user at the client device, wherein the advertisement information is based on the context information. The method further includes presenting the advertisement information by the first portable program module to the user.

### CROSS-REFERENCE TO RELATED APPLICATIONS

This application claims priority to U.S. application Ser. No. 61/066,132, filed on Oct. 15, 2007, and entitled, “Communicating Context Information Among Portable Program Modules.”

### TECHNICAL FIELD

This document discusses communicating context information from one portable program module to another for use in, for example, targeting advertisements.

### BACKGROUND

Targeted web advertising has become an important industry. Like traditional advertising, the success of web advertising may depend on providing advertisement information that is relevant to a particular viewer presented with the advertisement information. Web advertising can be provided with search results generated by Internet search engines. In such a situation, the advertisements selected for display may be matched to terms in the search request. Google Adwords™ provided by Google™ of Mountain View, Calif. is an example of such targeted advertising. Targeted advertisements may also be delivered apart from search, such as on web pages themselves. For example, an ad system may analyze the content of a web page to determine important words or concepts to associate with the page, and may deliver ads directed to those words or concepts when the page is displayed. Such delivery may occur when the page is retrieved for a user, with the host of the page delivering the page content and the ad server delivering the targeted advertising. Google AdSense™ also provided by Google™ is an example of such targeted advertising.

### SUMMARY

This document describes mechanisms and techniques that may be employed to provide context information from one portable program module to another portable program module in a web-based document such as a web page. For example, a web page or a program may act as a container document for a portable program module such as a gadget. A first gadget may be programmed to provide context information to a second gadget. The second gadget submits the context information to an advertisement serving system and in response receives targeted advertisement information based on the context information. The second gadget may display an advertisement using the targeted advertisement information.

In one implementation, a computer-implemented method is disclosed. The method includes receiving, at a first portable program module in a first web-accessible container document at a client device, context information from a second portable program module in a second web-accessible container document at the client device. The method further includes identifying advertisement information for presentation to a user at the client device, wherein the advertisement information is based on the context information. The method further includes presenting the advertisement information by the first portable program module to the user.

Implementations can include any, all, or none of the following features. The first web-accessible container document can include the second web-accessible container document. The context information can include information about the user at the client device. The context information received by the first portable program module can include a data value associated with a predetermined data label. Receiving the context information at the first portable program module can include receiving updates to the context information from the second portable program module in response to changes to the context information within the second portable program module. Presenting the advertisement information to the user at the client device can include determining a size of a display at the client device and formatting the advertisement information for presentation in the display. The method can include submitting the context information to an advertisement serving system and in response receiving at least a portion of the advertisement information from the advertisement serving system. Presenting the advertisement information to the user at the client device can include presenting one or more hyperlinks and reporting to the advertisement serving system a click event associated with the one or more hyperlinks. The method can include receiving at least a portion of the advertisement information from an advertiser system. Receiving the portion of the advertisement information can be in response to submitting at least a portion of the context information to the advertiser system. Receiving the portion of the advertisement information can be in response to submitting a previously received portion of the advertisement information to the advertiser system.

In one implementation, a computer-implemented method is disclosed. The method includes receiving at an advertisement serving system a request from a first portable program module in a web-accessible container document at a client device, wherein the request comprises context information communicated to the first portable program module from a second portable program module in the web-accessible container document. The method further includes determining advertisement information related to the context information. The method further includes outputting for presentation, in response to the request, advertisement information related to the context information.

In one implementation, a computer-implemented system is disclosed. The system includes a web-accessible container document at a client device comprising two or more portable program modules. The system further includes a context portable program module included in the two or more portable program modules for communicating context information to the two or more portable program modules. The system further includes means for receiving the context information from the context portable program module and for presenting advertisement information based on the context information. The system further includes means for receiving the context information from the context information receiving and advertisement information presenting means, selecting the advertisement information based on the context information, and sending the advertisement information to the context information receiving and advertisement information presenting means.

In one implementation, a computer program product tangibly embodied in a computer readable medium, the computer program product including instructions that, when executed, perform operations for targeting advertisements is disclosed. The operations include receiving, at a first portable program module in a web-accessible container document at a client device, context information from a second portable program module in the web-accessible container device. The operations further include identifying advertisement information for presentation to a user at the client device, wherein the advertisement information is based on the context information. The operations further include presenting the advertisement information by the first portable program module to the user.

Implementations can include any, all, or none of the following features. The context information can include a data value and a predetermined data label. The first portable program module and the second portable program module can communicate using a channel identified by the predetermined data label. The first portable program module and the second portable program module can communicate using a predetermined channel identifier.

The describes mechanisms and techniques may provide one or more of the following advantages. A first advantage may be provided where advertisers receive a high conversion rate on web advertisements due to targeting advertisements based on context communicated from a context gadget to an advertisement gadget. A second advantage may be provided where users are presented with highly relevant web advertisements due to targeting advertisements based on context communicated from a context gadget to an advertisement gadget. A third advantage may be provided where conversion rates on web advertisements are high for advertisers and web advertisements are highly relevant to users due to labeling or categorizing the context data communicated from a context gadget to an advertisement gadget.

The details of one or more embodiments are set forth in the accompanying drawings and the description below. Other features and advantages will be apparent from the description and drawings, and from the claims.

### DESCRIPTION OF DRAWINGS

FIG. 1 is a schematic diagram showing an example of a system for targeting advertisements based on context information from a portable program module.

FIG. 2A shows an example of a user interface of a context gadget.

FIG. 2B shows an example of a user interface of an advertisement gadget.

FIG. 3 is a schematic diagram showing an example of a system for targeting advertisements based on context information from a context gadget.

FIG. 4 is a flow chart showing an example of a process for generating a targeted advertisement based on context information from a context gadget.

FIG. 5 is a swim lane diagram showing an example of a process for generating a targeted advertisement based on context information from a context gadget.

FIG. 6 shows an example layout of a web-accessible container document that includes a context gadget and an advertisement gadget.

FIG. 7 is a schematic diagram showing an example of a system for dynamically generating a targeted advertisement based on context information from a context gadget.

FIG. 8 shows an example of a computer device and a mobile computer device that can be used to implement the techniques described here.

Like reference symbols in the various drawings indicate like elements.

### DETAILED DESCRIPTION

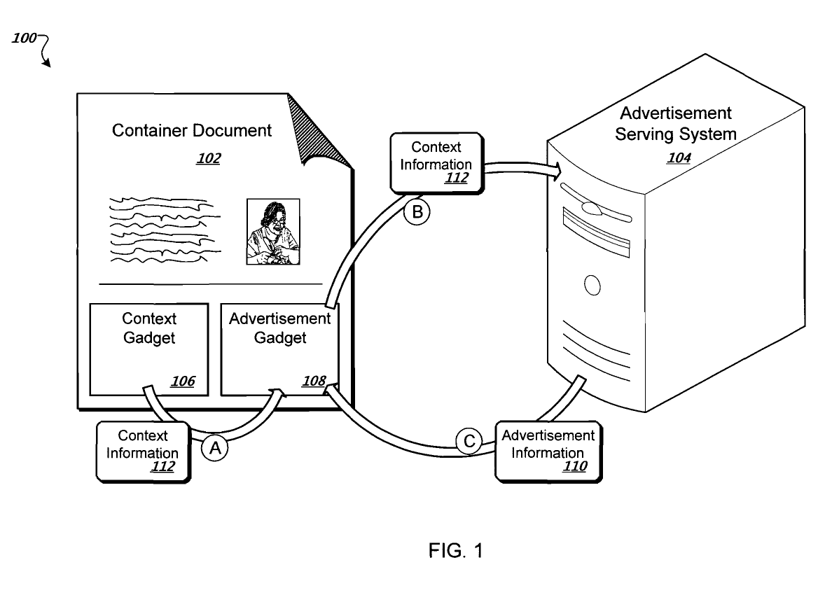

FIG. 1 is a schematic diagram showing an example of a system 100 for targeting advertisements based on context information from a portable program module. In the pictured example, the system 100 comprises a container document 102 and an advertisement serving system 104. The container document 102 in this example is a web page having multiple portable program modules, such as a context gadget 106 and an advertisement gadget 108. In general, these components cooperate to permit advertisements or other such displays containing real-time or near real-time data to be constructed and displayed to a user at run-time. As such, a targeted advertisement may be dynamically constructed, and thus may contain advertisement information 110 that is currently relevant to the user. In this example, the advertisement information 110 is related to context information 112 provided by the context gadget 106.

In addition, in certain implementations, the system 100 may be implemented with few or no adjustments to existing systems. For example, the advertisement gadget 108 may be programmed to submit standard Hypertext Transfer Protocol (HTTP) requests to the advertisement serving system 104 using agreed-upon API's that are the same as requests made by other systems (e.g., GET and POST requests). In addition, the context gadget 106 may communicate with the advertisement gadget 108 using an existing client scripting language, such as JavaScript, and an existing communication mode, such as JavaScript custom events. As such, the functionality described here may be added to a system without having to update server software or make other similar changes. In addition, such a system may provide additional flexibility, where authors and user of portable program modules may have more control over the manner in which their systems interact with the advertisement serving system 104.

Such techniques may, in certain implementations, provide one or more advantages. For example, in this example, a page may be able to provide viewers with up-to-date real-time advertisement information that may be particularly relevant to a user. For example, if the user is simply provided with information about a service, such as airfare booking at an airline website, with a mere indication that there might be relevant flights available, the user will be reticent to click through to review the flights because the clicking may be a waste of time. On the other hand, if the user sees an actual flight from the location of the user to a destination of interest to the user, the likelihood that the user will click on the advertisement should go up substantially.

The example implementation may have advantages to users, to advertisers, to advertising carriers, and to information providers. Users gain because they are provided with information that is more relevant to them. Advertisers gain because they can drive more viewers to their goods. Advertising carriers (e.g., an advertisement serving system), such as Google, gain because the advertisers that they serve gain. And information providers—the owners of the documents that contain the gadget ads and the owners of information provided by some context gadgets—gain because their viewers gain, and perhaps because they can obtain a share of the advertising revenue.

Referring to FIG. 1, the context gadget 106 and the advertisement gadget 108 are shown located in the container document 102. The context gadget 106 and/or the advertisement gadget 108 may include a display that is generated from mark-up code that is stored as part of, or referenced from, markup code that generates the container document 102. For example, the markup code may include various forms of hypertext markup language (HTML) code, such as code for generating the gadget on the display. The context gadget 106 and/or the advertisement gadget 108 may be part of an inline frame (iFrame) on a web page represented by the container document 102. In general, an iFrame is an HTML document that may be embedded in another HTML document, using an iFrame element. The document in which the iFrame is embedded, the container document 102 in this example, may be generated around the iFrame while the iFrame itself is still being generated.

Example HTML code for providing an iFrame in a web page includes the following:

```
<html>
. . .
    <iframe
  src=″http://gmodules.com/ig/ifr?url=http://www.google.com/ig/
  modules/datetime.xml ″ height=″100″ width=″200″
  frameborder=″0″ scrolling=″no″>
    </iframe>
. . .
</html>
```

As this code shows, the iFrame element may reference a document to be inserted in the iFrame, dimensions for the iFrame, and whether scrolling should be allowed inside the iFrame. The document in the iFrame can be replaced with another document or can be modified or refreshed without refreshing the container document (e.g., the surrounding page), by using the “target” attribute of an HTML anchor or by using JavaScript, such as in an AJAX (Asynchronous JavaScript and Extensible Markup Language) implementation. Similar displays may be generated, for example, through editing of a document's DOM (Document Object Model) tree.

The context gadget 106 and the advertisement gadget 108, such as when implemented in iFrames, may be concealed from the user. For example, the advertisement gadget 108 is intended for the user to see and possibly interact, therefore the advertisement gadget 108 is visible. However, it may be preferable to a user not to see another gadget that is simply performing functions to help a visible gadget or some other component, so such a gadget (e.g., the context gadget 106) may be generated in a manner so that it is not visible to a user viewing the container document 102.

The context gadget 106 communicates with the advertisement gadget 108 and the advertisement gadget 108 communicates with the advertisement serving system 104. In particular, the context gadget 106 communicates the context information 112 to the advertisement gadget 108. The context information 112 may include information relevant to a user viewing the container document 102, such as, for example, a postal code that identifies a general location of the user. The advertisement gadget 108 sends the context information 112 to the advertisement serving system 104. The advertisement serving system 104 uses the context information 112 to target the advertisement information 110 to the user viewing the container document 102. For example, the advertisement serving system 104 can target an advertisement to a service provided in the geographic location of the user as determined by the postal code.

In some implementations, the advertisement gadget 108 performs at least a portion of the operation of targeting the advertisement information 110 to the user. The advertisement gadget 108 may retrieve pre-targeted advertisement information from the advertisement serving system 104 and perform a targeting operation on the pre-targeted advertisement information. Alternatively, the advertisement gadget 108 may already include the pre-targeted advertisement information and subsequently performs the targeting based on the context information 112.

In some implementations, the context information 112 is structured. For example, the context information 112 may include labels, such as “latitude” and “longitude,” as well as values associated with the labels, such as 45° 07′ 14.48″ N. and 93° 24′ 07.81″ W., respectively. In some implementations, the labels provide the advertisement serving system 104 and/or the advertisement gadget 108 with a higher accuracy of advertisement targeting than keywords alone, due to the categorization provided by the labels. In some implementations, the labels are used as “channel” identifiers or custom event identifiers to which the context gadget 106 publishes and the advertisement gadget 108 subscribes. Alternatively, label names may be included within data provided through a channel or custom event. In some implementations, the channel names and/or label names are predetermined, such that a gadget developer may create gadgets that are capable of communicating with gadgets created independently by a another gadget developer.

In some implementations, the advertisement gadget 108 communicates with the container document 102. The container document 102 may display a variety of information, such as web pages for companies or social networking sites. The container document 102 may act as a context gadget and communicate context information to the advertisement gadget 108.

An example flow of operations in the system 100 is shown by lettered arrows in FIG. 1. In this particular example, the container document 102 is a web page for a publishing site, such as a blog. As such, the container document 102 provides for personalizing the search page with gadgets, such as the context gadget 106 and the advertisement gadget 108.

The context gadget 106 provides weather information to the user viewing the search page. The user has previously input a postal code or other geographic location information to allow the context gadget 106 to target weather forecasts to the user's geographic location. Alternatively, the context gadget 106 may determine the user's geographic location using another method, such as a geographic Internet Protocol (geo-IP) lookup, retrieval from a cookie or server, or communication with another gadget. The context gadget 106 publishes the geographic location and weather forecast information to a channel or custom event. The context gadget 106 may republish information as data changes, such as when the user inputs a new geographic location. In addition, the context gadget 106 may republish information periodically, such as every hour for updates to real-time forecast information.

The advertisement gadget 108 subscribes to the channel or custom event to which the context gadget 106 publishes. The advertisement gadget 108 receives the context information 112 published by the context gadget 106, including the geographic location of the user and the weather forecast from the location of the user. The advertisement gadget 108 sends the context information 112 to the advertisement serving system 104.

The advertisement serving system 104 performs a context analysis of the context information to determine a relevant advertisement for the user viewing the container document 102. For example, the advertisement serving system 104 may include a rule that associates an airline advertisement with cold weather forecasts. Also, the context information 112 may include additional information, such as an identifier (e.g., a uniform resource locator or identifier) of the container document 102. The advertisement serving system 104 may use the identifier to determine keywords associated with the container document 102, such as “tourism” or “Florida.” The advertisement serving system 104 may associate the determined keywords with the airline advertisement. The advertisement serving system 104 sends the advertisement information 110 for the airline flights to the advertisement gadget 108. The airline advertisement includes information targeted to the location of the user, the destination determined from the keywords, and the weather forecast information. The advertisement gadget 108 receives the advertisement information 110 and displays the airline advertisement to the user. In some implementations, the advertisement gadget 108 or another system performs the context analysis described above.

The request for advertisement information from the advertisement gadget 108 to the advertisement serving system 104 may be encrypted or otherwise protected from tampering. For example, a unique protocol may be agreed upon between the advertisement gadget 108 and the advertisement serving system 104 to prevent illegitimate requests for information from the advertisement serving system 104.

Upon receiving the advertisement information 110 from the advertisement serving system 104, the advertisement gadget 108 may analyze and format the advertisement information 110 for display to a user on the web page represented by the container document 102. For example, the advertisement gadget 108 may initially determine the size of its associated iFrame so as to determine how to size, scroll, or otherwise format the advertisement. For example, if the iFrame is very short, there may no be room for graphics (e.g., photos of airline destinations), and the advertisement gadget 108 may decline to display the graphics in such a situation.

In addition, the advertisement gadget 108 may determine that the iFrame is too small to display a full description of multiple items, and may thus choose to concatenate certain descriptions or to display only a subset of fields received from the advertisement serving system 104, such as displaying only a “short description” field for an advertisement. Also, the advertisement gadget 108 may choose to display more items than will fit in the iFrame, and may provide a scroll control to permit access to items that will not initially display. The advertisement gadget 108 may perform other formatting operations also, such as changing a font size, font style, white space size, or image presentation.

The gathering of the context information 112 from the context gadget 106, the submission of the context information 112 to the advertisement serving system 104, the receipt of the advertisement information 110 targeted for the user, and the display of the advertisement, may all occur, in appropriate implementations, while the page associated with the container document 102 is being loaded. As such, the display created by the advertisement gadget 108, such as an actively generated advertisement, may be viewable by a user almost immediately upon accessing and loading the associated web page.

The advertisement gadget 108 may also be provided with additional functionality for accessing information for display with the web page. For example, calls made by the advertisement gadget 108 may be conditional or iterative. As one example, the advertisement gadget 108 may request a limited number of results (e.g., flights from the airline), and when displaying those results, may display a control by which a user may seek additional results. In such a situation, the advertisement gadget 108 may then request the additional results. (The advertisement gadget 108 could also obtain all of the results initially and store some of the results until the user requests them.)

The advertisement displayed by the advertisement gadget 108 may include metadata, such as hyperlinks, that permits a user to interact with the results. For example, text displaying certain flights from the airline may be associated with a hyperlink whose selection causes a browser displaying the container document 102 to be redirected to a page showing details about the flight (or causes a new pane or new window to be open to display the flight detail screen).

Selection of such a hyperlink may also cause a message to be transmitted to the advertisement serving system 104 or a server associated with the advertisement serving system 104, so as to report the user's selection. For example, an advertisement serving system may bill advertisers based on the number of times that users click on a particular advertisement, and such a message may permit an advertisement serving system to properly bill an advertiser, such as the airline. In addition, the advertisement gadget 108 may report back the particular flight the user selected within the advertisement, so that more detailed reporting and billing may occur. As one example involving the airline system, a flight may include an ID number assigned by the airline, and the advertisement gadget 108 may pass that ID number to the advertisement serving system 104 when a user selects the flight. The advertisement serving system 104 may then provide the number to the airline at an appropriate time, such as at a time when the selection is billed to the airline. In addition to using such information to pass on advertising costs to its users in a fair and tracked manner, the airline may use such information to help analyze the effectiveness of providing certain information in an advertisement, among other things.

The requests by the advertisement gadget 108 to the advertisement serving system 104 may be cached in certain implementations. Such caching may permit for increased performance, as the various requests described above may require relatively extensive searching and processing, particular when performed in very large numbers. For example, if the advertisement gadget 108 for an advertisement like that discussed above is placed on the front page of a popular website, there may be hundreds of thousands of page loads that would each require complete searching and processing by the advertisement serving system 104. Caching may allow the search and processing to occur once, with subsequent requests being served simply by looking them up in the cache.

When such caching occurs, it may be implemented at various levels, including in the browser, at an ISP or corporate server, and at central information providers such as Google. At the browser, when a user returns to a web page (e.g., when returning to a newspaper's main home page after reading an article) that is a container for a portable program module or gadget like that described above, the module code may simply return the information that it obtained the first time the page was loaded. Caching at an ISP may avoid any need to hit the advertisement serving system 104 at all after a first user seeks information from those sources. And caching at the advertisement serving system 104 does involve some load on those systems, but avoids the need to re-query and re-process in manners that could be much more expensive than simply looking for information in the cache.

Caching may be controlled to expire by various mechanisms, particularly when the data displayed by the advertisement gadget 108 is real time data like weather information. For example, the context gadget 106 and/or the advertisement gadget 108 may include a refresh interval parameter that determines how often information is sent and/or retrieved. In some implementations, the caching may be disabled to send and/or retrieve information as the information is published by a gadget. In addition, where caching is used or could be used, the advertisement gadget 108 may be programmed to format items in anticipation of such caching.

In one particular example, the context gadget 106 is a map gadget that stores a home location of the user, such as a postal address of a home location. The context gadget 106 subsequently communicates the context information 112 to the advertisement gadget 108. The context information 112 includes the home location (e.g., the postal address or latitude and longitude coordinates). The advertisement gadget 108 sends the context information 112 to the advertisement serving system 104. The advertisement serving system 104 determines that there are advertisements available that are local to the user's geographic location, such as an advertisement for a local hardware or a local bank (e.g., the hardware store and/or bank may be within a few miles of the user's location). Consequently, the advertisement information 110 includes a message regarding the local hardware store and/or bank. The advertisement serving system 104 sends the advertisement information 110 to the advertisement gadget 108 where the advertisement information 110 is presented to the user.

In another example, the context gadget 106 is a weather gadget that retrieves weather forecast information from a weather forecast publisher site. The context gadget 106 uses geographic location information, such as the continent, country, or state provided by the user, to retrieve a weather forecast targeted for the user's location. The context gadget 106 subsequently communicates the context information 112 to the advertisement gadget 108. The context information 112 includes the geographic location information and next week's weather forecast for the location. The advertisement gadget 108 sends the context information 112 to the advertisement serving system 104. The advertisement serving system 104 determines that an airline advertisement is relevant to the context information 112. Consequently, the advertisement information 110 includes a message regarding the weather next week at the user's location and airline flight information for travel to a warmer location. The advertisement serving system 104 sends the advertisement information 110 to the advertisement gadget 108 where the advertisement information 110 is presented to the user. In another implementation, the container document 102 passes content information, such as the geographic location information, to the advertisement gadget 108.

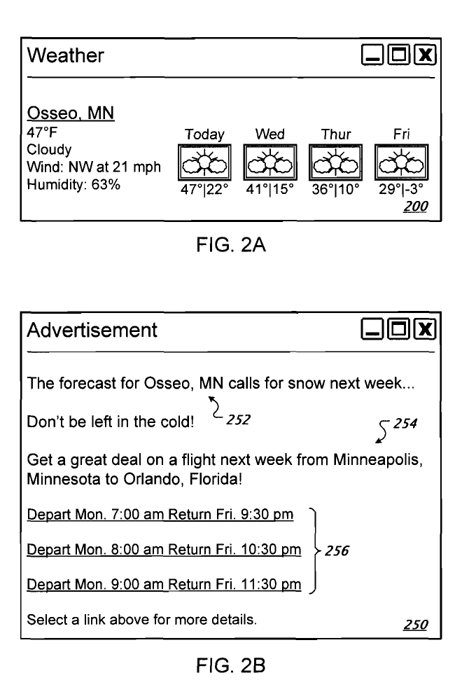

FIG. 2A shows an example of a user interface 200 of the context gadget 106. The user interface 200 presents weather forecast information, such as current temperature (“47° F.”), cloud cover (“Cloudy”), wind (“NW at 21 mph”), and humidity (“63%”), as well as high and low daily temperatures for the week and pictorial representations of daily cloud cover. The weather forecast information is targeted to a geographic location, in this case, the geographic location of the user. The user may input a geographic location identifier to the context gadget 106 or the context gadget 106 may determine the geographic location as previously described.

In some implementations, the context gadget 106 retrieves the forecast information from an external source. For example, the context gadget 106 may receive the forecast information from a web-accessible weather forecast publisher. The weather forecast publisher may provide at least a portion of the context information 112 to the context gadget 106. The context gadget 106 can request and receive the portion using standard protocols, such as HTTP. The context gadget 106 subsequently broadcasts or selectively communicates the context information 112 using the channel or custom event. The context information 112 may include the information shown in the user interface 200 and/or additional weather forecast information, such as a forecast for the following week.

FIG. 2B shows an example of a user interface 250 of the advertisement gadget 108. The user interface 250 presents the airline flight advertisement as determined in the advertisement information 110 received from the advertisement serving system 104. The user interface 250 includes a message 252 targeted for the geographic location of the user (“Osseo, MN”) as well as the weather forecast for the location of the user (“snow next week”). The user interface 250 also includes a message 254 targeted for additional information, such as the nearest commercial airport (“Minneapolis, Minnesota”) to the geographic location and keywords (“Florida” and “tourism”) from the container document 102 as previously described.

The user interface 250 includes a list 256 of hyperlinks presenting specific information about available flights during the snowy week. The hyperlinks provide navigation to a site where the user can see more information about the flights and book travel on the flights. In some implementations, the hyperlinks contain information that allows the advertisement serving system 104 to track user activity in the airline advertisement as previously described.

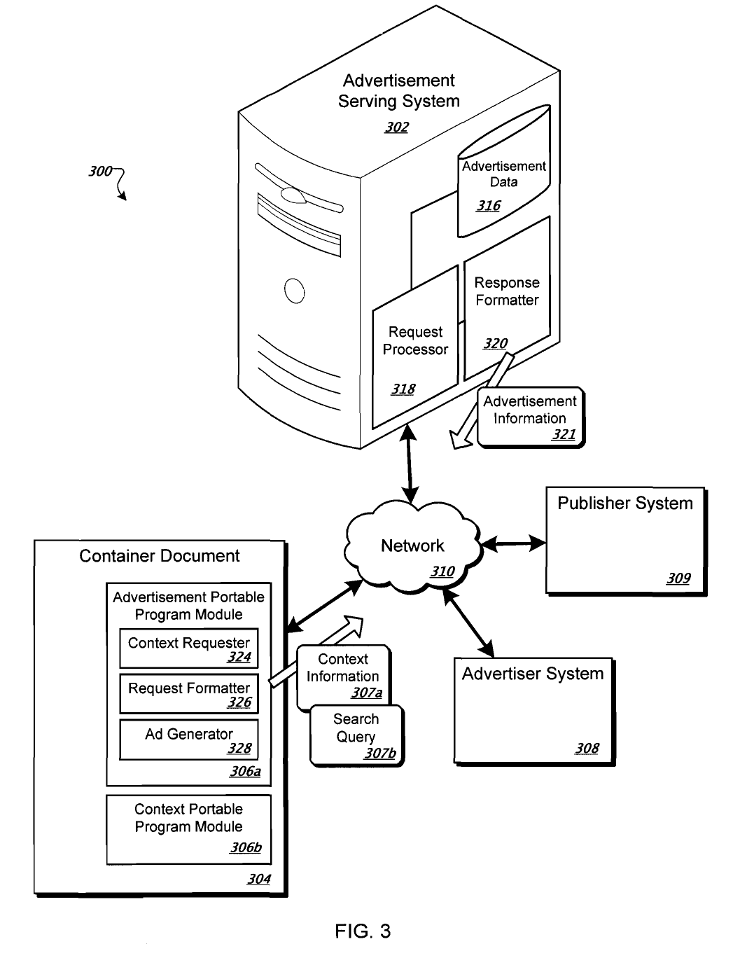

FIG. 3 is a schematic diagram showing an example of a system 300 for targeting advertisements based on context information from a context gadget. In general, the components shown in FIG. 3 may take a form similar to those shown in FIG. 1. Additional detail and structure for certain of the components is shown here for additional illustration of the operation of the system 300.

The system 300 includes an advertisement serving system 302 and a container document 304. The container document 304 includes an advertisement portable program module 306a and a context portable program module 306b. The advertisement serving system 302 and the container document 304 may access an advertiser system 308 or a publisher system 309 through a network 310 such as the Internet. The container document 304 may have a number of parameters associated with it, including its URL and/or keywords. The advertisement portable program module 306a includes code and a resulting display that is embedded in the container document 304, and may include code that is referenced from the container document 304. As described above, the advertisement portable program module 306a may be implemented to provide a display in an iFrame on a web page associated with the container document 304.

The advertisement portable program module 306a includes a number of components that permit it to obtain information about the container document 304 and/or the context portable program module 306b to retrieve and display content such as a dynamically generated advertisement using such information. For example, a context requester 324 is a program module that communicates with the context portable program module 306b, such as by communicating with a browser program displaying the container document 304. The context requester 324 may obtain various parameters that define the context of the context portable program module 306b, such as a geographic location or weather forecast information, among other things. The context portable program module 306b may have previously received the context information or a portion thereof from the publisher system 309.

The advertisement portable program module 306a also includes a request formatter 326. The request formatter 326 may be used to generate requests to the advertisement serving system 302 using the context information obtained by the context requester 324. In addition, the request formatter 326 may receive responses from the advertisement serving system 302, and use information in such responses to generate an advertisement.

In some implementations, the advertisement portable program module 306a may use the advertisement information and/or context information to make a request or requests to the advertiser system 308, such as a query designed to generate a list of items showing real time information tracked by the advertiser system 308 (e.g., available seats in a particular flight). The advertisement portable program module 306a generates and displays an advertisement based on the real time information received from the advertiser system 308.

In addition, the advertisement portable program module 306a can also include an advertisement generator 328. The advertisement generator receives information such as that returned from the advertiser system 308, including real time information, and formats the received information for display on a web page associated with the container document 304, in manners like those discussed above.

The advertisement portable program module 306a can generate various forms of messages to be communicated to and over the network 310. Message 307a is a message, in the form of a request (e.g., HTTP request) to the advertisement serving system 302 including context information relating to the context of the context portable program module 306b that has been gathered by the advertisement portable program module 306a. Message 307b is a search query, which may be submitted in a form according to a standard API to the advertiser system 308 (or to a web server associated with the advertiser system 308).

The advertiser system 308 itself may take a variety of forms consistent with the techniques described here. In certain implementations, the advertiser system 308 may track real time, constantly changing information. In such implementations, the advertisement portable program module 306a can be used to gather such information and dynamically generate content such as advertisements, to be displayed on a web page associated with the container document 304. The advertiser system 308 may generally be configured to generate messages in the form of search results that are responsive, for example, to search queries from the advertisement portable program module 306a. Other messages may also be generated and transmitted by the advertiser system 308 as appropriate.

The advertisement serving system 302 may include a number of components and structures for supporting the generation of targeted advertisements to viewers of internet web pages. The advertisements may be generated for inclusion on pages of an organization that operates the advertisement serving system 302 (e.g., search result pages) or may be generated for inclusion through a syndication program on third party web pages. As with the other devices here, the advertisement serving system 302 may include one or more different computers and/or computer systems; the particular grouping of modules and structures is shown here simply for illustrative purposes.

The advertisement serving system 302 receives messages from other components at a request processor 318. The request processor 318 may parse and analyze incoming messages to determine how to respond. For example, the request processor 318 may analyze the structure of an incoming request to determine that certain advertisement information associated with context information in the request should be returned. As such, the request processor may access an advertisement data 316, which includes information that correlates particular advertisement information to context information. The accessing may be through a simple look up that uses labels and values in the context information as a key.

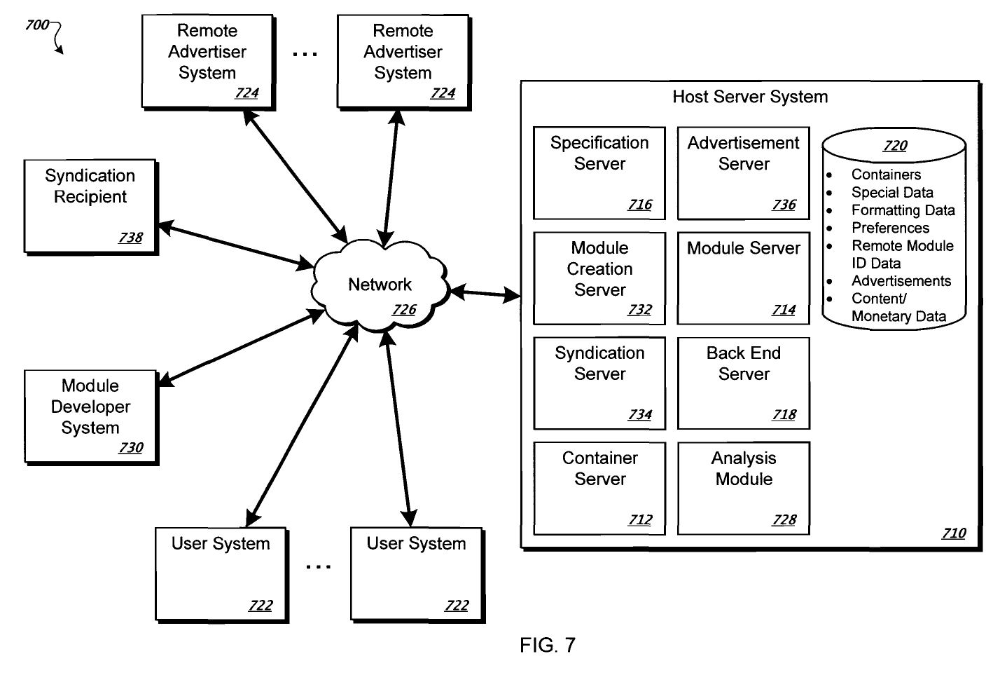

When responses have been generated, they may be returned to a requester by a response formatter 320. The response formatter 320 may, for example, reformat database results received from a query of the advertisement data 316 into one or more XML messages to be returned to the advertisement portable program module 306a. The messages may include, for example, an advertisement information 321. Various other services may also be provided by the advertisement serving system 302, though limited services have been shown here to increase clarity. For example, static advertisements may be served up by the advertisement serving system 302 and may be delivered for display on a web page associated with the container document 304—without the need to reference a separate source of real time information like the advertiser system 308. Other services may also be provide, as may be described more fully with respect to FIG. 7 below.

In some implementations, one or more of the advertisement portable program module 306a, the advertisement serving system 302, and the advertiser system 308 may perform the operation of targeting advertisement information to a user based on the context information. In addition, the advertisement portable program module 306a may receive pre-targeted and/or post-targeted advertisement information from the advertisement serving system 302 and/or the advertiser system 308. Alternatively or in addition, the advertisement portable program module 306a may already include pre-targeted advertisement information with which it performs the advertisement targeting operation. In some implementations, the advertisement portable program module 306a receives an advertisement selection from a first source (e.g., the advertisement serving system 302) and real time data for display with the selected advertisement from a second source (e.g., the advertiser system 308).

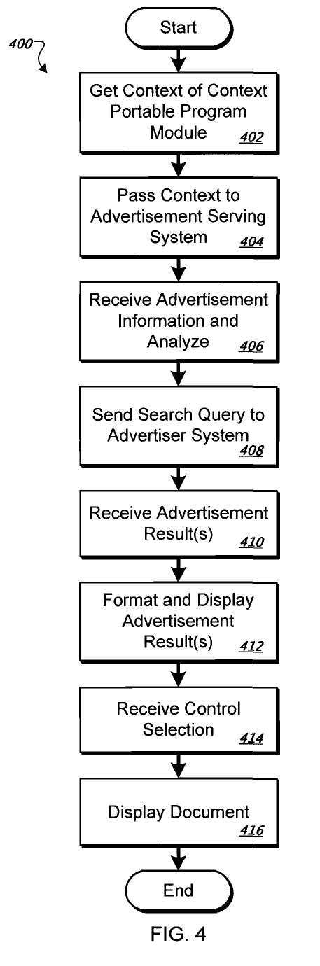

FIG. 4 is a flow chart showing an example of a process 400 for generating a targeted advertisement based on context information from a context gadget. In general, the process shows actions that may be taken by an advertisement portable program module (APPM) in gathering and displaying an advertisement to a viewer of a web page. The process 400 broadly involves gathering information from a document or other portable program module, such as a container document or a context portable program module (CPPM), submitting the gathered information (or a derivative of the gathered information) to a remote server, receiving information from the remote server in response (e.g., information providing information that is descriptive of a related advertisement), submitting the received information (or a derivative of the received information) to another remote server, receiving information in return from the other remote server, and displaying the received information.

At box 402, the APPM initially obtains information about a “context” of the CPPM and/or a container document for the APPM. The context may include many different sorts of information, and may include, for example, text of a main heading in the container document, a URL for the container document, a set of links in the container document, a geographic location, weather forecasts, etc.

The APPM then, at box 404, passes the context information to an advertisement serving system. The APPM may first alter or otherwise reformat the context information, such as by adding certain parameters to the information, where the parameters may be used by the advertisement serving system to determine what actions to take with respect to the submitted information. The advertisement serving system may use the passed information to generate a response, such as by identifying advertisement information that is related to the context passed to the advertisement serving system. The advertisement serving system may then pass back such information, such as in the form of keywords or other advertisement information, to the APPM, as shown by box 406.

At box 408, the APPM sends the advertisement information or a portion thereof to an advertiser system in a search query. The APPM can analyze the received advertisement information, and may add to it, alter it, or simply pass it on without any change other than perhaps a formatting change (e.g., from XML to HTTP request that matches an API for the advertiser system). In addition, the APPM may make other determinations, such as by selecting an advertiser system, from multiple such advertiser systems, to receive the query. The APPM may then wait while the advertiser system applies the submitted query to its data and generates a response. The response may include, for example, one or more items responsive to the query.

At box 410, the APPM receives the advertisement results from the advertiser system, and at box 412, it formats and displays the advertisement results. The formatting may include eliminating certain of the results for display, and also determining the form or size of the space for the APPM and arranging information regarding the returned items so as to fit in the allotted space.

The APPM may then wait for an action. At box 414, the APPM receives a control selection, such as by a user clicking on a hyperlink representing an item displayed by the APPM. The selected hyperlink may cause a browser that is displaying the APPM to display to the user a detail page that is the target of the selected hyperlink. By this process, a centrally located APPM may coordinate the passing of information needed to gather data for displaying a dynamically rendered advertisement, and to display such an advertisement for interaction with a user.

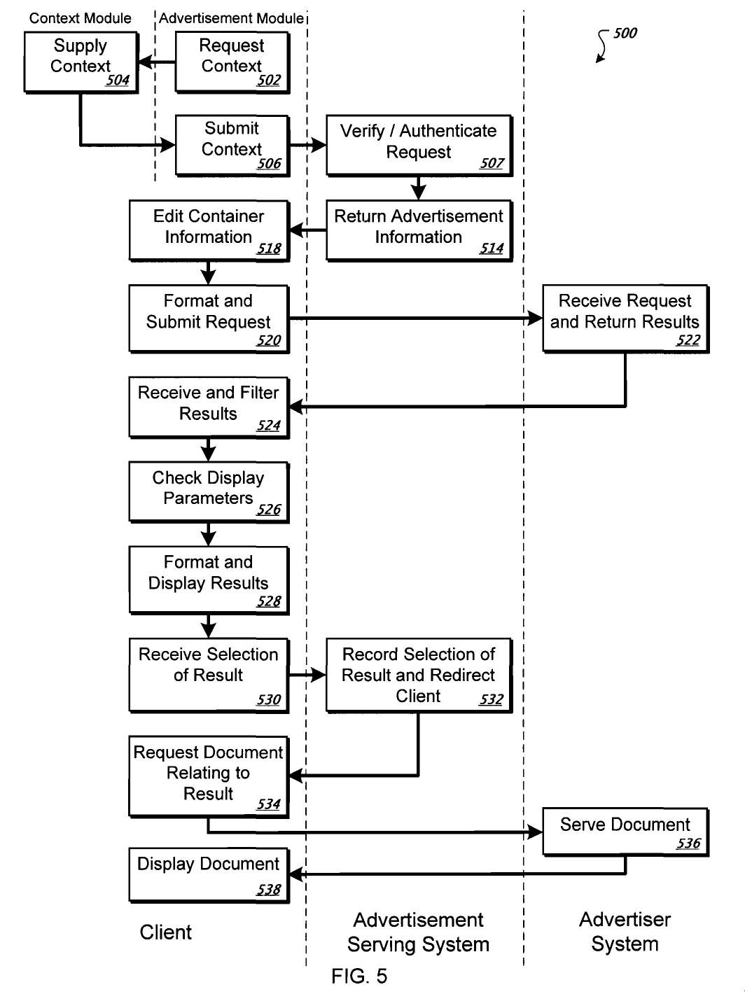

FIG. 5 is a swim lane diagram showing an example of a process 500 for generating a targeted advertisement based on context information from a context gadget. In general, the process 500 shows an example of interactions between a client device, an advertisement serving system, and an advertiser system, which may be structures like those shown in FIGS. 1 and 3.

The example process begins at box 502, where an advertiser portable program module on a web page on the client requests information about the context of the web page. A context portable program module, the container document, or another appropriate structure responds by providing contextual information, such as a URL and geographic location. The advertisement portable program module then submits information relating to the context (e.g., the URL and location information) to a remote server such as an advertisement serving system (box 506).

Upon receipt of the request, the advertisement serving system may initially authenticate the request (box 507). For example, the advertisement serving system may compare a historical effect of context information associated with the context portable program module on advertisement targeting to determine if the context portable program module is manipulating or spamming the advertisement serving system. Alternatively or in addition, the context information may include an identifier that identifies the context portable program module. The server then determines whether advertisement information that is related to the context information is available, e.g., whether keywords or concepts describing the context and the advertisement have previously been generated and stored by the server. If such information has been stored, it can simply be returned to the client (box 514). In addition, if a request for the same information has recently been made, a cache may intercept the request and answer it, without the need for additional searching on the server (not shown).

At box 518, the APPM edits the received information, such as by selecting certain keywords to pass to the advertiser system, or by simply reformatting the received information into a request that matches a format that is acceptable to the advertiser system. At box 520, the client finishes reformatting the request and submits it to the advertiser system, which receives the request and returns results corresponding to the request (box 522). The advertiser system may operate according to the various procedures discussed above or according to other appropriate processes.

The client then receives the results at box 524 and filters them or otherwise changes them, such as by adding or eliminating certain results that are determined to not display properly with the container document. In making a decision of what results to display, and how to display them, the APPM may check display parameters, such as the size of an iFrame or similar structure in which the display is to occur (box 526). The client may then format and display the results (box 528), such as is shown in, for example, FIG. 2.

After a time, a user may select one of the results displayed by the APPM (box 530), which may cause an HTTP request to be delivered to the advertisement serving system (box 522) where the hyperlinks for the items are formatted to be directed to the advertisement serving system. The advertisement serving system may then redirect the user's client application (e.g., browser) to the advertiser system (boxes 532 and 534). By having the item's hyperlink point to the advertisement serving system, and pointing the browser to the advertiser system by redirection rather than directly, the process 500 may give the advertisement serving system notice that the item has been clicked on, so that the advertisement serving system may bill the advertiser for the click. In other circumstances, the advertising may be billed differently, such as by a cost per impression billing technique.

At box 534, the client requests a document relating to the result returned by the advertisement serving system. The requested document may be a document generally, or may more specifically involve submitting a query to the advertiser system. The advertiser system may then serve the requested document (box 536), which serving may involving querying a database of real time changing information, and returning matching items from the database. Finally, at box 538, the client displays the document, which may involve formatting XML-based data received from the advertiser system for display on a web page, such as in a gadget.

Boxes 534, 536, and 538 may be repeated. For example, the user may make another input in the advertisement portable program module requesting additional or updated advertisement information be displayed in the advertisement portable program module. The advertisement portable program module may include user input controls (e.g., next and previous list controls or expand and minimize controls) for requesting additional or updated data from the advertiser system or the advertisement serving system.

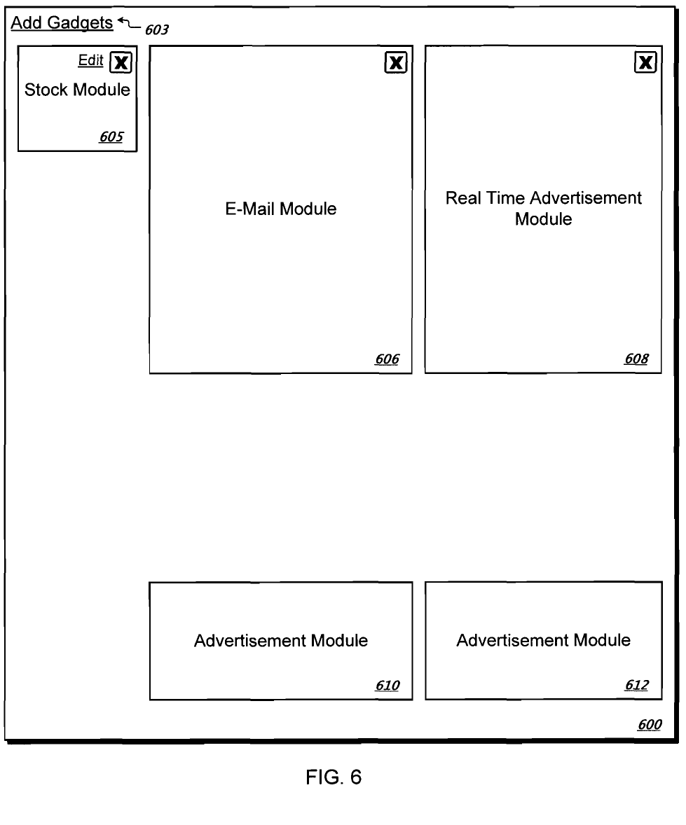

FIG. 6 shows an example layout of a container document 600 that is web-accessible and includes a context gadget and an advertisement gadget. A number of methods of incorporation are possible, including the use of the iFrame and inline HTML techniques. FIG. 6 depicts a plurality of modules including a stock module 605, an e-mail module 606, a real-time ad module 608, and multiple ad modules 610 and 612. Different formats for the various modules may exist depending upon the specifications provided by the creator of the module. Some modules may provide scroll bars, and others may not. Some modules may be different sizes or shapes than other modules. In addition, some modules may offer an opportunity for the user to edit the display preferences and/or per-use data associated with the module.

In one implementation, inlined modules may be automatically sized by a container document so no scrolling, height or scaling information may be provided. If a module developer wants the module to have these properties in this embodiment, an inlined module may be wrapped with a fixed size <DIV> tag and content placed in the tag. The scroll bar, height, and other characteristics may be then specified for the inlined content. One of the attributes allows specifying scaling =“. . . ” to let the developer indicate how a module may be scaled up or down for different sizes of placements in the container documents.

One of the functions provided with this example of the container document 600 is the opportunity to add content to the container page through selecting an add content element 603. Upon selecting the add content element 603, the system may offer the user the opportunity to interactively indicate an additional element to be included in the container page. Various forms of an interface to receive that input may be provided.

In addition, in adding, editing or deleting modules, it may be desired to have those activities occur without a refresh of the container document. One illustrative technique for achieving this may involve use of AJAX programming techniques so a module may be added to a container document without a refresh of the container document page (perhaps only a refresh of the IFRAME in which the new container is presented), or use of AJAX to remove a module without the container document being refreshed or when a developer is developing a module, being able to change modules without the container document in which they are populated having to have a page refresh in order to incorporate the changed module.

FIG. 7 is a schematic diagram showing an example of a system 700 for dynamically generating a targeted advertisement based on context information from a context gadget. In general, the system 700 is a more general representation of a system that employs portable program modules, such as gadgets, for various operations. The general operations described here are, when appropriate, applicable to the systems shown in FIGS. 1 and 3. System 700 may include a host server system 710 with a plurality of modules that may be associated therewith. Such modules may comprise a container server 712, a module server 714, a specification server 716, a back end server 718, an analysis module 728, a module creation server 732, a syndication server 734, and an advertisement server 736. As illustrated, the host server system 710 may connect over a network 726 to a plurality of other systems or sub-systems.

Other systems connected to the network may comprise one or more user systems 722, one or more remote advertiser systems 724, one or more module developer systems 730 and one or more syndication recipient servers, such as a syndication recipient server 738. In addition, one or more database systems 720 may operate in conjunction with the various modules of the host server system 710.

Container server 712 may serve container documents to the user systems 722 over the network 726. Container server 712 may use a web server or related server systems that take data and/or instructions and formulate containers for transmission over the network to the user systems 722. However, the container server 712 may reside on a user system as well, so that a network connection may not be used. In the example in which the container document includes a word processing document, for example, the container server 712 may comprise a word processing module.

The module server 714 may provide data from modules to the container server 712 for incorporation into a container document. In one embodiment, the container server 712 and the module server 714 may comprise a single unit performing both functions, as may other servers and modules described herein. The module server 714 may provide data for the container document by interpreting and/or parsing instructions in a module specification associated with the module. According to one embodiment, the module server 714 may serve the module content to the container document through the use of a browser iFrame.

To expedite display of container documents, modules may be displayed inline within the container document. Inline display may be understood as referring to display with other document elements. One example is a display generated from code for HTML in the body according to HTML standards. In one embodiment, the module server 714 or some other component may determine whether the module is deemed trusted prior to including it in the container document due to the risks of various security issues an inline module could create. According to one embodiment, the module may incorporate an indicium of approval (e.g., digital certificate) issued by the container module or an entity associated with the container module. If the indicium of approval is present, the module server 714 may render the data from a module for inline presentation in the container document.

The specification server 716 provides a module specification file to the module server 714. The module specification may be cached and stored in a database accessible to the module server 714 and/or the specification server 716 or may be retrieved from a location associated with the specification as detailed later. For example, the specification server 716 may reside on one of the remote advertiser systems 724. In addition, the specification server 716 may be connected to the module server 714 over a network with the module specification located at another location on the network accessible to the specification server 716.

The back end server 718 may be provided for interacting with one or more databases (e.g., large or dynamic databases of information). For example, for a news module that obtains frequent updates and demands a flow of data, (e.g, from an RSS feed), the back end server 718 may format the data into HTML for the container.

In one specific example, a person may create a module (e.g., a maps module), such as one that uses an application program interface (API) to an existing mapping program to create a module to display a map of downtown Mountain View, Calif. The module may include an XML specification file or module specification file stored on a specification server. The specification server may comprise any appropriate server, including one on a site from which the container page is hosted. The user or another person may then include this new module on a personalized homepage or another form of web page (container document). The server that serves the container document may operate as the module server, and the server that generates the mapping data through an inquiry from its API may be considered to be the back end server.

In one implementation, the analysis module 728 may analyze modules at various times (e.g., when the module is first selected by a user, each time the module is called by a container for inclusion or at any other time determined to be advantageous for safety and security and other times). The analysis module 728 may perform a number of actions, including comparing the module with a list of disapproved or dangerous modules or a list of approved modules. The comparison may involve exact or substring (e.g., prefixes, suffixes and regular expressions) matching by name or location (e.g., URL), contents of the specification, contents of the location where the specification resides, or information that may be ascertainable about the module.

The analysis module 728 may take one or more actions in response to a determination that the module is disapproved or dangerous, including, for example, silently blocking the request, (i.e. providing a generic error), blocking the request with an error that explains the reason it was blocked or redirecting the request to a different module specification that has been determined to be safe and related to the disapproved module (e.g., another module that relates to maps, if the first one was a disapproved mapping site or a module that includes the keyword “basketball” if the disapproved module was a basketball module). For example, through redirection, the URL of the original module may be passed to the “safe” module. The safe module may then use a proxy server, as described below, to retrieve the original URL's content. Developers may then replace the error handler to fix small bugs in the original module to be able to display the content of the original module. In another embodiment, the analysis module 728 may parse the module content to determine whether it is safe, such as by compiling JavaScript or other scripts contained in the module to try to identify unsafe or undesired actions the module may perform.

One or more module creation server, such as the module creation server 732, may be provided. These servers may operate as “wizards” to enable module creators to create a module through an interactive process. For example, the module creation server 732 may provide a series of user interfaces that enable a person creating a module to provide inputs that are used to automatically generate a module specification. For example, various module specification templates may be provided with corresponding inputs. The module creation server 732 may then take inputs supplied by a user, insert them into a template, and generate a module specification for the module. A preview, testing, and debugging function may also be offered as part of this “wizards.” This module may be downloadable to a client as well.

The syndication server 734 may prepare data for transmission to one or more syndication recipient servers, such as the syndication recipient server 738, related to modules. The syndication server 734 may receive a request for a module and/or module content and deliver that module or content to the syndication recipient server 738 over the network 726. The syndication server 734 may reside at the host server system 710 or at another location on the network.

For example, if an operator of a sports web site (an example of the syndication recipient server 738) desires to include an advertising module created by one of the remote advertiser systems 724, it may do so through a request to the syndication server 734. The syndication server 734 may then cooperate with the module server 714 to generate data for the container document (here the sports web site page of the syndication recipient server 738). That may involve retrieving the module specification from one of the remote advertiser systems 724, supplying preferences received from the syndication recipient server 738 (e.g., city information for the sports team of a page being displayed) and/or generating data for the container. It is also possible that the data may be rendered at the syndication recipient server 738 into its container document in either an IFRAME or inline. The syndication server 734 may thus syndicate modules accessible to it. It may do so based on requests for specific modules or other criteria it determines (e.g., content matches, keyword matches, monetary values associated with modules and/or syndication requestors, etc.).

The advertisement server 736 may provide advertisements associated with modules to containers and/or data for creating a display for such modules. For example, an advertisement may be incorporated with module data when data is delivered to a container document. The advertisement server 736 may operate with the syndication server 734 to deliver advertisements to one or more syndication recipient servers, such as the syndication recipient server 738, based on a syndication request for a module. The advertisements may be selected by the advertisement server 736 based on a wide variety of criteria, including, but not limited to, the relationship between the content of or information about the container, module, other modules in the container, syndication recipient server information, monetary elements/relationships related to any of the foregoing and/or combinations thereof. The ad server 36 may comprise the Google AdSense system, according to one embodiment of the present invention. The advertisement server 736 may operate as described in one or more of the following patent applications, the subject matter of which is hereby incorporated by reference in their entirety. Specifically, the advertisement server 736 may manage online advertising by associating two or more concepts related to a module with an advertisement and associating a bid, collectively, with the two or more keywords. In addition, the syndication server 734 or the advertisement server 736 may respond to requests from syndicated modules such as advertising-related modules that send requests for information describing container pages associated with the modules.

The database systems 720 may be provided to store, in any number of appropriate manners, container information, module specifications and/or related information, formatting data, per-user and per-module preference data, remote module ID data, remote module location reference data, advertisement data, advertiser data, content/monetary data, syndication recipient data, templates for modules, inputs for modules, lists of trusted and untrusted modules, approval criteria and related information and/or any other information used by the modules to operate as described herein. While a single database structure is shown, the data may be stored at a number of locations and in one or more systems.

In one implementation, systems and method are provided to incorporate modules into a container document. One example of a container document would be a personalized home page, such as the Google Personalized Homepage currently available to users of the Google services on the Internet. Instead of restricting the types of content that a user is able to include in a container document such as a personalized home page, one or more embodiments of the present invention enable users to select modules from sources other than the source of the container document. So, for example, a user may elect to include a module in his or her personalized Google home page from a source not associated with Google.

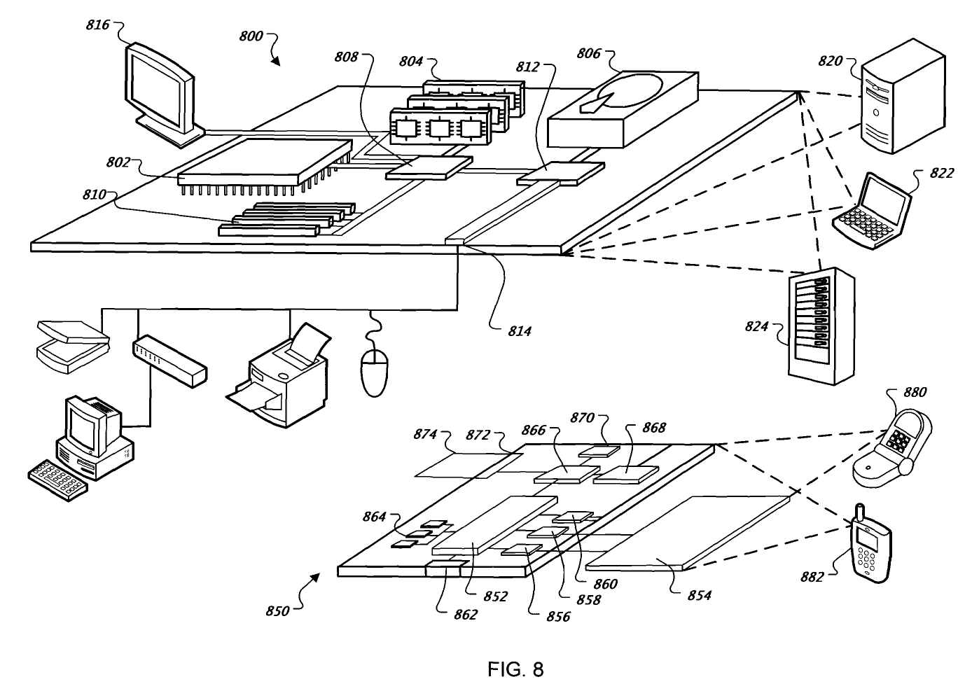

FIG. 8 shows an example of a computing device 800 and a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, memory on the processor 802, or a propagated signal.

The high-speed interface 808 manages bandwidth-intensive operations for the computing device 800, while the low-speed interface 812 manages lower bandwidth-intensive operations. Such allocation of functions is exemplary only. In one implementation, the high-speed interface 808 is coupled to the memory 804, the display 816 (e.g., through a graphics processor or accelerator), and to the high-speed expansion ports 810, which may accept various expansion cards (not shown). In the implementation, the low-speed interface 812 is coupled to the storage device 806 and the low-speed expansion port 814. The low-speed expansion port 814, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. In addition, it may be implemented in a personal computer such as a laptop computer 822. It may also be implemented as part of a rack server system 824. Alternatively, components from the computing device 800 may be combined with other components in a mobile device (not shown), such as a mobile computing device 850. Each of such devices may contain one or more of the computing device 800 and the mobile computing device 850, and an entire system may be made up of multiple computing devices communicating with each other.

The mobile computing device 850 includes a processor 852, a memory 864, an input/output device such as a display 854, a communication interface 866, and a transceiver 868, among other components. The mobile computing device 850 may also be provided with a storage device, such as a microdrive or other device, to provide additional storage. Each of the processor 852, the memory 864, the display 854, the communication interface 866, and the transceiver 868, are interconnected using various buses, and several of the components may be mounted on a common motherboard or in other manners as appropriate.

The processor 852 can execute instructions within the mobile computing device 850, including instructions stored in the memory 864. The processor 852 may be implemented as a chipset of chips that include separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. The memory 864 can be implemented as one or more of a computer-readable medium or media, a volatile memory unit or units, or a non-volatile memory unit or units. An expansion memory 874 may also be provided and connected to the mobile computing device 850 through an expansion interface 872, which may include, for example, a SIMM (Single In Line Memory Module) card interface. The expansion memory 874 may provide extra storage space for the mobile computing device 850, or may also store applications or other information for the mobile computing device 850. Specifically, the expansion memory 874 may include instructions to carry out or supplement the processes described above, and may include secure information also. Thus, for example, the expansion memory 874 may be provide as a security module for the mobile computing device 850, and may be programmed with instructions that permit secure use of the mobile computing device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, the expansion memory 874, memory on the processor 852, or a propagated signal that may be received, for example, over the transceiver 868 or the external interface 862.

The mobile computing device 850 may communicate wirelessly through the communication interface 866, which may include digital signal processing circuitry where necessary. The communication interface 866 may provide for communications under various modes or protocols, such as GSM voice calls, SMS, EMS, or MMS messaging, CDMA, TDMA, PDC, WCDMA, MA2000, or GPRS, among others. Such communication may occur, for example, through the transceiver 868 using a radio-frequency. In addition, short-range communication may occur, such as using a Bluetooth, WiFi, or other such transceiver (not shown). In addition, a GPS (Global Positioning System) receiver module 870 may provide additional navigation- and location-related wireless data to the mobile computing device 850, which may be used as appropriate by applications running on the mobile computing device 850.

The mobile computing device 850 may also communicate audibly using an audio codec 860, which may receive spoken information from a user and convert it to usable digital information. The audio codec 860 may likewise generate audible sound for a user, such as through a speaker, e.g., in a handset of the mobile computing device 850. Such sound may include sound from voice telephone calls, may include recorded sound (e.g., voice messages, music files, etc.) and may also include sound generated by applications operating on the mobile computing device 850.

The mobile computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ad servers ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

1. A computer-implemented method, comprising:
receiving, at a targeted advertising portable program module of a web page and from a context portable program module that is configured to display real-time or near real-time information on the web page, context information that is associated with the real-time or near real-time information, the web page serving as a container document for the targeted advertising portable program module and for the context portable program module;
modifying, by the targeted advertising portable program module, the context information by including instructions for an advertising server to process the context information;
transmitting, from the targeted advertising portable program module of the web page, over a network connection to the advertising server, the modified context information;
receiving, at the targeted advertising portable program module of the web page and from the advertising server upon processing the instructions in the modified context information, advertisement information associated with the modified context information; and information;
caching, by the targeted advertising portable program module, a portion of the advertisement information associated with the modified context information;
presenting, by the targeted advertising portable program module and to the user, an on screen visualization of a remaining portion of the advertisement information in the web page and a control for presenting additional advertisement information in the web page;
receiving, by the targeted advertising portable program module, data indicating an interaction with the control for presenting additional advertisement information in the web page;
in response to receiving the data indicating the interaction with the control for presenting additional advertisement information, accessing, by the targeted advertising portable program module, the cached portion of the advertisement information; and
presenting, by the targeted advertising portable program module and to the user, an additional on screen visualization of the cached portion of the advertisement information.

2. (canceled)

3. The method of claim 1, wherein the context information comprises information about the user.

4. The method of claim 1, wherein the context information received by the targeted advertising portable program module comprises a data value associated with a predetermined data label.

5. The method of claim 1, wherein receiving the context information at the targeted advertising portable program module comprises receiving updates to the context information based upon changes of the web page and in response to changes to the context information within the context portable program module.

6. The method of claim 1, wherein presenting an on screen visualization of a remaining portion of the advertisement information to the user in the web page and a control for presenting additional advertisement information in the web page comprises:
determining a size of the display; and
formatting, based on the size of the display, the on screen visualization of the remaining portion of the advertisement information and the control for presentation in the display.

7-8. (canceled)

9. The method of claim 1, wherein presenting an on screen visualization of a remaining portion of the advertisement information to the user in the web page and a control for presenting additional advertisement information in the web page comprises presenting one or more hyperlinks received from the advertising server.

10. The method of claim 9, further comprising reporting to the advertising server a click event associated with the one or more hyperlinks.

11-21. (canceled)

22. The method of claim 1, wherein the targeted advertising portable program module is displayed in a first iFrame of the web page and the context portable program module is displayed in a second iFrame of the web page.

23. A system, comprising:
one or more computers and one or more storage devices storing instructions that are operable, when executed by the one or more computers, to cause the one or more computers to perform operations comprising:
receiving, at a targeted advertising portable program module of a web page and from a context portable program module that is configured to display real-time or near real-time information on the web page, context information that is associated with the real-time or near real-time information, the web page serving as a container document for the targeted advertising portable program module and for the context portable program module;
modifying, by the targeted advertising portable program module, the context information by including instructions for an advertising server to process the context information;
transmitting, from the targeted advertising portable program module of the web page, over a network connection to the advertising server, the modified context information;
receiving, at the targeted advertising portable program module of the web page and from the advertising server upon processing the instructions in the modified context information, advertisement information associated with the modified context information;
caching, by the targeted advertising portable program module, a portion of the advertisement information associated with the modified context information;
presenting, by the targeted advertising portable program module and to the user, an on screen visualization of a remaining portion of the advertisement information in the web page and a control for presenting additional advertisement information in the web page;
receiving, by the targeted advertising portable program module, data indicating an interaction with the control for presenting additional advertisement information in the web page;
in response to receiving the data indicating the interaction with the control for presenting additional advertisement information, accessing, by the targeted advertising portable program module, the cached portion of the advertisement information; and
presenting, by the targeted advertising portable program module and to the user, an additional on screen visualization of the cached portion of the advertisement information.

24. The system of claim 23, wherein the context information comprises information about the user.

25. The system of claim 23, wherein the context information received by the targeted advertising portable program module comprises a data value associated with a predetermined data label.

26. The system of claim 23, wherein receiving the context information at the targeted advertising portable program module comprises receiving updates to the context information based upon changes of the web page and in response to changes to the context information within the context portable program module.

27. The system of claim 23, wherein presenting an on screen visualization of a remaining portion of the advertisement information to the user in the web page and a control for presenting additional advertisement information in the web page comprises:
determining a size of the display; and
formatting, based on the size of the display, the on screen visualization of the remaining portion of the advertisement information and the control for presentation in the display.

28. (canceled)

29. The system of claim 23, wherein presenting an on screen visualization of a remaining portion of the advertisement information to the user in the web page and a control for presenting additional advertisement information in the web page comprises presenting one or more hyperlinks received from the advertising server.

30. The system of claim 29, wherein the operations further comprise reporting to the advertising server a click event associated with the one or more hyperlinks.

31. (canceled)

32. The system of claim 23, wherein the targeted advertising portable program module is displayed in a first iFrame of the web page and the context portable program module is displayed in a second iFrame of the web page.

33. A non-transitory computer-readable medium storing software comprising instructions executable by one or more computers which, upon such execution, cause the one or more computers to perform operations comprising:
receiving, at a targeted advertising portable program module of a web page and from a context portable program module that is configured to display real-time or near real-time information on the web page, context information that is associated with the real-time or near real-time information, the web page serving as a container document for the targeted advertising portable program module and for the context portable program module;
modifying, by the targeted advertising portable program module, the context information by including instructions for an advertising server to process the context information;
transmitting, from the targeted advertising portable program module of the web page, over a network connection to the advertising server, the modified context information;
receiving, at the targeted advertising portable program module of the web page and from the advertising server upon processing the instructions in the modified context information, advertisement information associated with the modified context information;
caching, by the targeted advertising portable program module, a portion of the advertisement information associated with the modified context information;
presenting, by the targeted advertising portable program module and to the user, an on screen visualization of a remaining portion of the advertisement information in the web page and a control for presenting additional advertisement information in the web page;
receiving, by the targeted advertising portable program module, data indicating an interaction with the control for presenting additional advertisement information in the web page;
in response to receiving the data indicating the interaction with the control for presenting additional advertisement information, accessing, by the targeted advertising portable program module, the cached portion of the advertisement information; and
presenting, by the targeted advertising portable program module and to the user, an additional on screen visualization of the cached portion of the advertisement information.

34. The medium of claim 33, wherein the context information comprises information about the user.

35. The medium of claim 33, wherein the context information received by the targeted advertising portable program module comprises a data value associated with a predetermined data label.

36. The medium of claim 33, wherein receiving the context information at the targeted advertising portable program module comprises receiving updates to the context information based upon changes of the web page and in response to changes to the context information within the context portable program module.

37. The medium of claim 33, wherein presenting an on screen visualization of a remaining portion of the advertisement information to the user in the web page and a control for presenting additional advertisement information in the web page comprises:
determining a size of the display; and
formatting, based on the size of the display, the on screen visualization of the remaining portion of the advertisement information and the control for presentation in the display.

38. (canceled)

39. The medium of claim 33, wherein presenting an on screen visualization of a remaining portion of the advertisement information to the user in the web page and a control for presenting additional advertisement information in the web page comprises presenting one or more hyperlinks received from the advertising server.

40-41. (canceled)

42. The medium of claim 33, wherein the targeted advertising portable program module is displayed in a first iFrame of the web page and the context portable program module is displayed in a second iFrame of the web page.

43. The method of claim 1, further comprising selecting, by the targeted advertising portable program module, a particular advertising server from multiple advertising servers to receive the modified context information as a search query.

44. The method of claim 1, further comprising:
modifying, by the targeted advertising portable program module, the remaining portion of the advertisement information associated with the modified context information; and
presenting, by the targeted advertising portable program module, an on screen visualization of the modified remaining portion of the advertisement information to the user in the web page.

45-48. (canceled)

49. The method of claim 1, wherein accessing, by the targeted advertising portable program module, the cached portion of the advertisement information comprises:
accessing, by the targeted advertising portable program module, the cached portion of the advertisement information without communicating with the advertising server.

50. The method of claim 1, wherein modifying, by the targeted advertising portable program module, the context information by including instructions for an advertising server to process the context information comprises:
modifying, by the targeted advertising portable program module, the context information by including instructions for an advertising server to process the context information and by selecting a subset of the context information based on characteristics of the advertising server.

51. The method of claim 1, comprising:
determining display parameters of a display presenting the web page; and
based on the display parameters, selecting a subset of the advertisement information,
wherein caching, by the targeted advertising portable program module, a portion of the advertisement information associated with the modified context information comprises caching, by the targeted advertising portable program module, a portion of the subset of the advertisement information associated with the modified context information.
